(19) United States
(12) Patent Application Publication
(10) Pub. No.: US 2019/0250805 A1
(43) Pub. Date: Aug. 15, 2019

(54) SYSTEMS AND METHODS FOR MANAGING COLLABORATION OPTIONS THAT ARE AVAILABLE FOR VIRTUAL REALITY AND AUGMENTED REALITY USERS

(71) Applicant: Tsunami VR, Inc., Del Mar, CA (US)

(72) Inventors: Beth BREWER, Escondido, CA (US); David ROSS, San Diego, CA (US); Alexander F. HERN, San Diego, CA (US); Anthony DUCA, San Diego, CA (US); Kyle PENDERGRASS, San Diego, CA (US)

(21) Appl. No.: 16/271,662

(22) Filed: Feb. 8, 2019

Related U.S. Application Data
(60) Provisional application No. 62/628,865, filed on Feb. 9, 2018.

(51) Int. Cl. G06F 3/0484; G06F 3/0482; H04L 29/06; H04L 12/18

(52) U.S. Cl. CPC G06F 3/04847; H04L 12/1822; H04L 67/38; G06F 3/0482

(57) ABSTRACT

Systems, methods, and computer-readable media for operating a collaborative virtual environment among a plurality of user devices communicatively are provided. The method can include establishing a collaboration session among multiple AR/VR/MR user devices. The method can include determining one or more user sensitivities associated with the user devices in the session indicating operating characteristics of the various user devices. The method can include determining one or more selectable options associated with each user sensitivity that indicate, enable, or limit one or more functions associated with the collaboration session among the user devices. The method can include performing one or more functions in response to the user selection of the first selectable option.

### CROSS REFERENCE TO RELATED APPLICATIONS

This application claims priority to U.S. Provisional Patent Application Ser. No. 62/628,865, filed Feb. 9, 2018, entitled “SYSTEMS AND METHODS FOR MANAGING COLLABORATION OPTIONS THAT ARE AVAILABLE FOR VIRTUAL REALITY AND AUGMENTED REALITY USERS,” the contents of which are hereby incorporated by reference in their entirety.

### BACKGROUND

### Technical Field

This disclosure relates to virtual reality (VR), augmented reality (AR), and mixed reality (MR) technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology including interactive environments and interactive three-dimensional (3D) virtual objects. Users of MR visualizations and environments can move around the MR visualizations and interact with virtual objects within the virtual environment.

Interactive 3D virtual objects can be complex and contain large amounts of information that describe different features of the virtual objects, including the geometry, appearance, scenery, and animation of the virtual objects. Particular features of a virtual object may include shape, surface geometry, color, texture, material type, light sources, cameras, peripheral objects, animation, physical properties, and kinematics.

MR, VR, and AR (or similar) devices can provide complex features and high-fidelity of representations of a physical world that can be useful in instruction or various types of training curricula or programs.

### SUMMARY

An aspect of the disclosure provides a method for operating a collaborative virtual environment among a plurality of user devices communicatively coupled to a platform providing the virtual environment. The method can include establishing a collaboration session by one or more processors of the platform based on a request from a first user device of the plurality of user devices, the first user device being operated by a first user originating the collaboration session. The method can include receiving, at the one or more processors, a selection input from the first user device, the selection input indicating selection of a second user device of the plurality of user devices to join the collaboration session. The method can include determining, by the one or more processors, one or more user sensitivities associated with the second user device, the user sensitivities indicating operating characteristics of the second user device. The method can include determining, by the one or more processors, one or more selectable options associated with each user sensitivity of one or more user sensitivities. The method can include causing the one or more selectable options to be displayed at the first user device, the selectable options indicating one or more functions associated with the collaboration session between the first user device and the second user device. The method can include receiving, in response to the displaying, a first user selection of a first selectable option. The method can include performing, by the one or more processors, a first function of the one or more functions, with regard to communications with the second user device, in response to the user selection of the first selectable option.

The one or more functions can enable the second user to selectively display of the collaborative session at the second user device.

The method can include determining if an action associated with each selectable option of the one or more selectable options can be performed in part or in whole by the first user device. The method can include including in the one or more selectable options, only the selectable options in the one or more selectable options that, that if selected, result in performance of actions that can be performed in part or in whole by the first user device.

The method can include receiving a selection of a selected device at the first user device. The method can include determining a location of the selected device. The method can include determining that the selected user device is the second user device based on the location of the selected user device. The method can include performing the first function based on a permission level of the second user. The one or more selectable options can include establishing or muting real-time communication between the first user device and the second user device based on a selection at the first user device.

The one or more selectable options can include transmitting content or disabling transmission of content between the first user device and the second user device based on a selection at the first user device. The content can include a presentation of work instructions.

The first user device can be one of an augmented reality (AR) device and a virtual reality (VR) device and the second user device comprises the other of the AR device and the VR device.

The second user device can selectively display the content in their environment.

Another aspect of the disclosure provides a non-transitory computer-readable medium comprising instructions for operating a collaborative virtual environment among a plurality of user devices communicatively coupled to a platform providing the virtual environment. When executed by one or more processors the instructions cause the one or more processors to establish a collaboration session by one or more processors of the platform based on a request from a first user device of the plurality of user devices, the first user device being operated by a first user originating the collaboration session. The instructions cause the one or more processors to receive a selection input from the first user device, the selection input indicating selection of a second user device of the plurality of user devices to join the collaboration session. The instructions cause the one or more processors to determine one or more user sensitivities associated with the second user device, the user sensitivities indicating operating characteristics of the second user device. The instructions cause the one or more processors to determine one or more selectable options associated with each user sensitivity of one or more user sensitivities. The instructions cause the one or more processors to cause the one or more selectable options to be displayed at the first user device, the selectable options indicating one or more functions associated with the collaboration session between the first user device and the second user device. The instructions cause the one or more processors to receive, in response to the displaying, a first user selection of a first selectable option. The instructions cause the one or more processors to perform a first function of the one or more functions, with regard to communications with the second user device, in response to the user selection of the first selectable option.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of system for creating computer-generated virtual environments and providing the virtual environments as an immersive experience for VR, AR and/or MR users;

FIG. 1B is a functional block diagram of user device for use with the system of FIG. 1;

FIG. 2 shows a method for managing collaboration options that are available for VR and/or AR users.

FIG. 3A and FIG. 3B depict examples of selectable options that are associated with user sensitivities, and examples of performable actions that are associated with selectable options.

FIG. 4 shows one embodiment for using one or more user sensitivities to determine a group of one or more selectable options.

### DETAILED DESCRIPTION

This disclosure relates to different approaches for managing collaboration options that are available for VR and/or AR users.

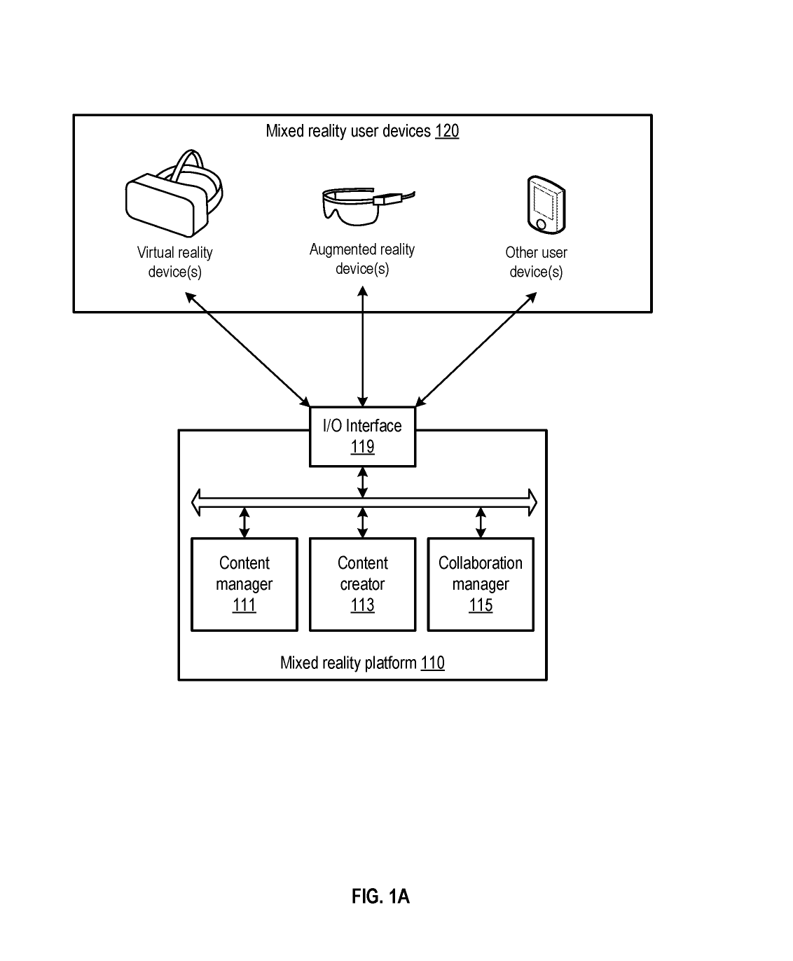

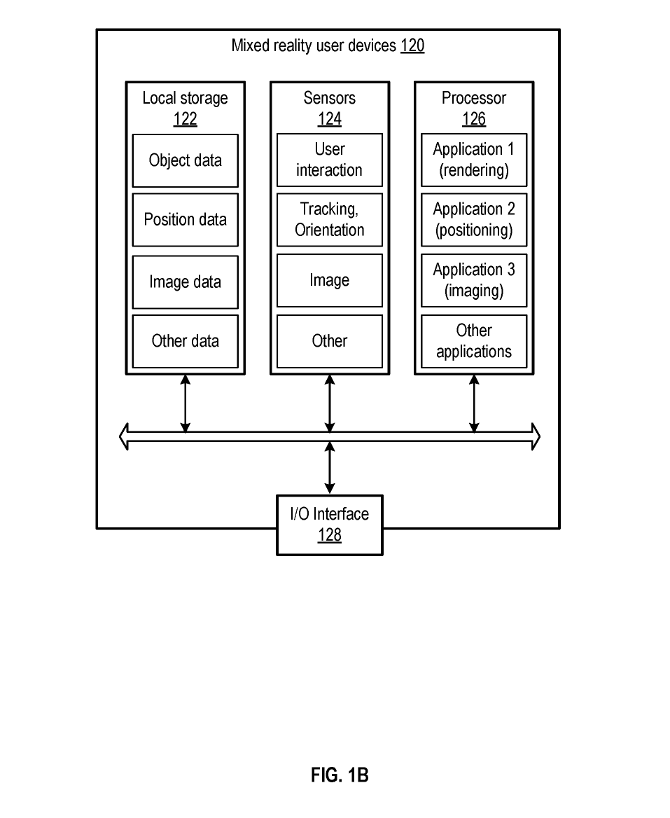

FIG. 1A is a functional block diagram of system for creating computer-generated virtual environments and providing the virtual environments as an immersive experience for VR, AR and/or MR users. Embodiments of the system depicted in FIG. 1A include a system on which a VR device can emulate user experience of an AR device. The system includes a mixed reality platform 110 that is communicatively coupled to any number of mixed reality user devices 120 such that data can be transferred between them as required for implementing the functionality described in this disclosure. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 113 creates a virtual environment, and also creates visual representations of things as virtual content (e.g., virtual objects, avatars, video, images, text, audio, or other presentable data) that can be displayed in a virtual environment depending on a user's point of view. Raw data may be received from any source, and then converted to virtual representations of that data (i.e., virtual content). Different versions of virtual content may also be created and modified using the content creator 113. The content manager 111 stores content (e.g., in a memory) created by the content creator 113, stores rules associated with the content, and also stores user information (e.g., permissions, device type, or other information). The collaboration manager 115 provides portions of a virtual environment and virtual content to each of the user devices 120 based on conditions, rules, poses (e.g., positions and orientations) of users in a virtual environment, interactions of users with virtual content, and other information. The I/O interface 119 provides secure transmissions between the platform 110 and each of the user devices 120.

FIG. 1B is a functional block diagram of user device for use with the system of FIG. 1. Each of the user devices 120 includes different architectural features, and may include the features shown in FIG. 1B, including a local storage 122, sensors 124, processor(s) 126, and an input/output interface 128. The local storage 122 stores content (e.g., in a memory) received from the platform 110, and information collected by the sensors 124. The processor 126 runs different applications needed to display any virtual content or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of user devices 120 include head-mounted displays, AR glasses, smart phones and other computing devices capable of displaying virtual content, and other suitable devices. By way of example, AR devices may include glasses, goggles, a smart phone, or other computing devices capable of projecting virtual content on a display of the device so the virtual content appears to be located in a physical space that is in view of a user.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine fields of view, and each field of view is used to determine what virtual content is to be rendered using the processor 126 for presentation to the user on a display of a user device. Tracking the positions and orientations of the user or any user input device (e.g., a handheld device) may also be used to determine interactions with virtual content. In some embodiments, an interaction with virtual content (e.g., a virtual object) includes a modification (e.g., change color or other) to the virtual content that is permitted after a tracked position of the user or user input device intersects with a point of the virtual content in a geospatial map of a virtual environment, and after a user-initiated command is provided to make the desired modification. Positions in a physical environment may be tracked in different ways, including positioning using Global Navigation Satellite Systems (GNSS), Bluetooth, WiFi, an altimeter, or any other known way to estimate the position of a thing (e.g., a user) in a physical environment.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual content among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, MR and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

The methods or processes outlined and described herein and particularly those that follow below, can be performed by one or more processors of the platform 110 either alone or in connection or cooperation with the user device(s) 120. The processes can also be performed using distributed or cloud-based computing.

Managing Collaboration Options that are Available for VR and/or AR Users

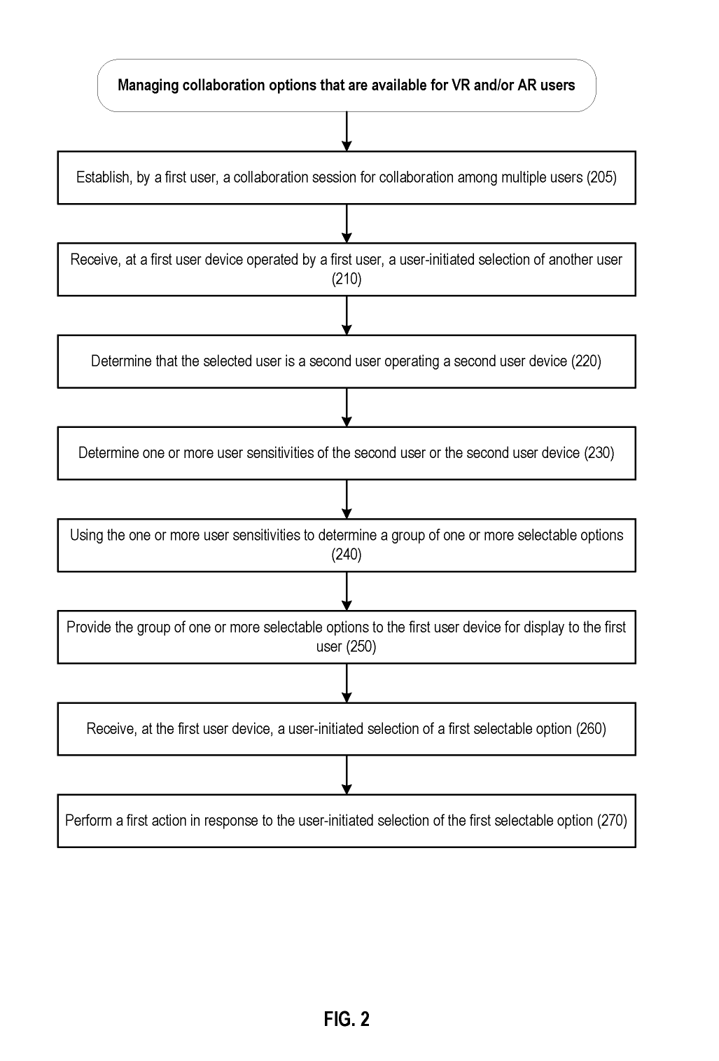

FIG. 2 is a flowchart of a method for managing collaboration options available to VR and/or AR users. In general, the method of FIG. 2 can allow an originator (e.g., a user or user device 120) or narrator of a VR/AR collaboration session to select virtual content for viewing by other collaborating user devices. The platform 110 can capture information related to user device sensitivities (or user sensitivities) and present such information and possible display or collaboration options to the originator/narrator (e.g., the user device 120 thereof). The originator can then select how to best present the material or virtual content to other user devices in the collaboration. This can provide additional control and options to the originator as opposed to allowing the platform 110 to autonomously control the version of content each user (or user device) receives based on their device (e.g., the user device 120) type and capabilities or technology supported by the device. This can include enabling a user device other than the originating user device to control how content is displayed or arranged. For example, the user device 120 can be VR-, AR-, or MR-enabled.

The method of FIG. 2 can be implemented using the system of FIG. 1A and the user device of FIG. 1B, for example. A first user, as an originator of a collaboration, operating a first user device (e.g., originator device) can establish a collaboration session (205). In general, the platform 110 can receive an input from the first user device to create the collaborative session and then host or otherwise perform the tasks or functions associated with the following method steps (FIG. 2). The collaboration session can provide a virtual collaborative environment in which multiple users can interact via their respective user devices 120. The collaborative environment, and the method of FIG. 2, can provide a process for interoperability of user devices having varying capabilities. For example, one user device 120 can be an AR device while another can be a VR device or an MR device. Thus, a plurality of user devices operating in the collaborative virtual environment may necessarily have differing capabilities, which can therefore affect the manner in which each respective AR/VR/MR user can participate in the collaborative session. In some examples, once the collaborative session is established, the first user can invite other users to join the collaborative session.

The first user, as the originator of the collaborative session, selects another user (210). Examples of selections include: using a gesture by the first user or a peripheral controlled by the first user to uniquely identify or otherwise select the other user. By way of example, the selection of the other user may be accomplished by selecting a virtual representation of the other user (e.g., an image of the user, an avatar representing the user, or other visual representation that uniquely identifies the user) or by selecting the other user from a menu option, list of users, directory of users, or similar mechanism.

A determination is made that the selected user is a second user operating a second user device (220). The second user device may support a second technology that is a different from the technology of the first user device. For example, the first user device may be operating in VR while the second user device is operating in AR. In another example, the first user device is operating in AR while the second user device is operating in VR. In some examples, MR devices may also be present among a plurality of user devices associated with the collaborative session.

One or more user sensitivities of the second user or the second user device are determined (230). Examples of user sensitivities generally include capabilities (or limitations) of the second user device 120, related technology(ies), limitations of the location in which the second user is located, preferences of the second user, permissions of the second user, or other conditions associated with the second user or the second user device that can affect operations or interoperability of the second user device. For example, the second user device is an AR device having a fixed mount display that may not support projection of virtual objects or virtual content. In such an example, the system (e.g., the platform 110) can provide the second user device a video stream of the collaboration session. In another example, the second user device is an AR device that is capable of projecting virtual object and virtual content, but the second user is in a physical location that is not conducive to displaying the virtual objects and/or the virtual content. In this example, the system may allow the second user to selectively display and hide the virtual objects and/or virtual content. In another example, the first user device is an AR device and the second user device is a VR device. In this example, the first user device provides a geospatial scan of the physical area and physical objects within the area. The system uses the geospatial scan to create a virtual replica of the physical environment for display on the second user device. In another example, the first user device is an AR device and the second user device is a VR device. The system can provide a list of virtual content that is being presented by the first user's AR device to the second user device. The second user device can allow the second user to selectively display the virtual content in the user's virtual environment.

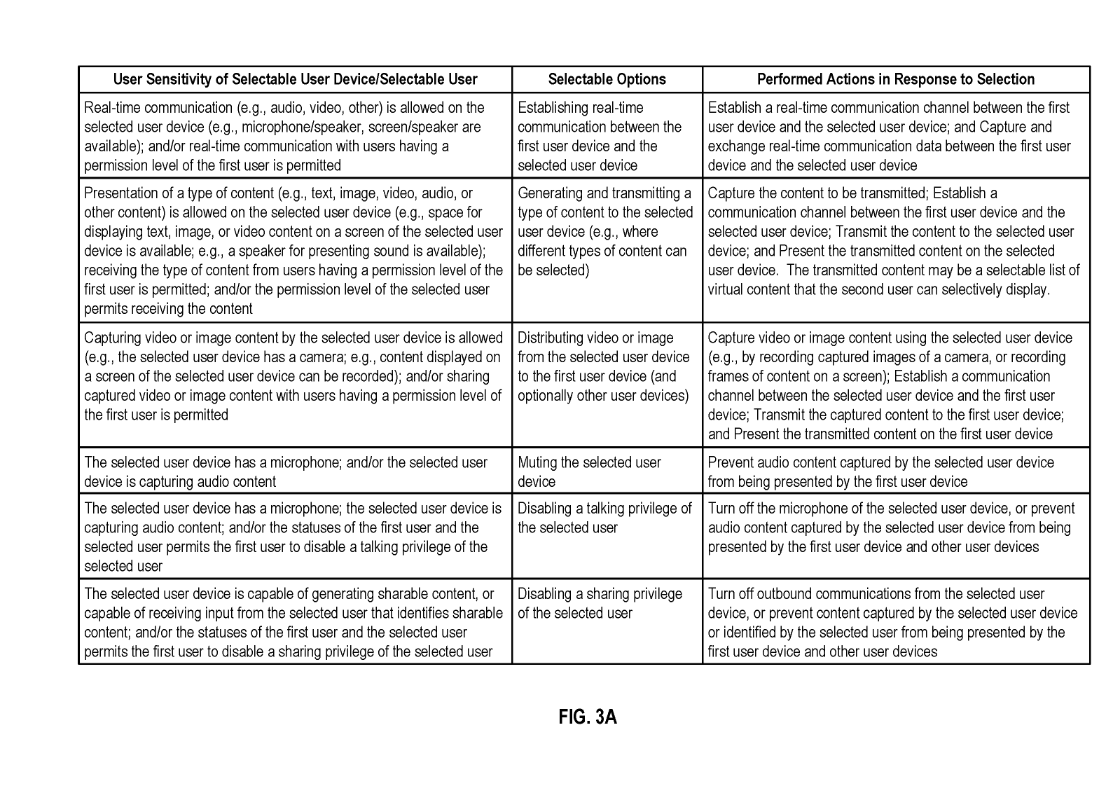

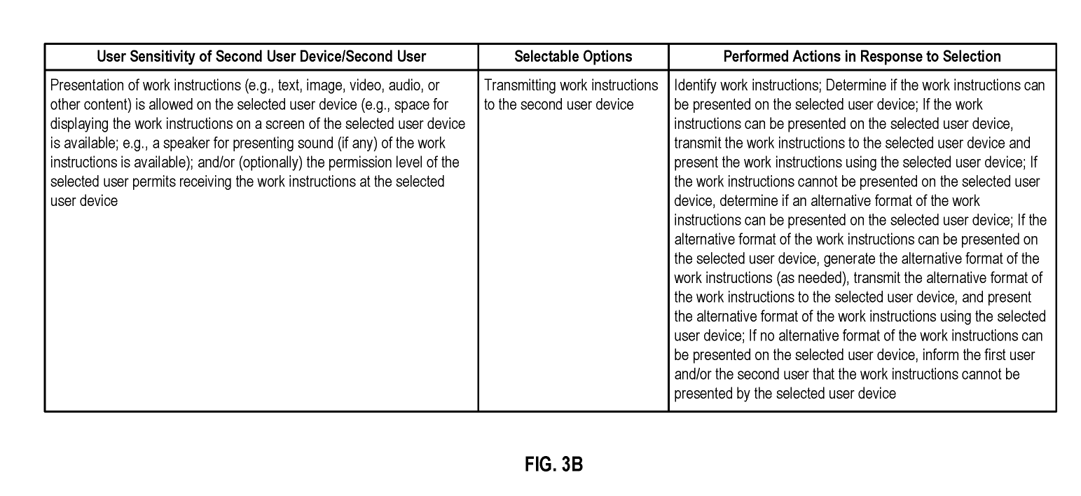

In one embodiment of step 230, the user sensitivities are stored in and looked up from a database (e.g., a memory) of stored values representing the user sensitivities that are associated with a particular user or user device (e.g., the second user or the second user device). In another embodiment of step 230, the user sensitivities are determined from hardware or software specifications of the second user device (e.g., whether the second user device has particular components or functions). By way of example, different user sensitivities are listed in the tables of FIG. 3A and 3B, which are discussed later.

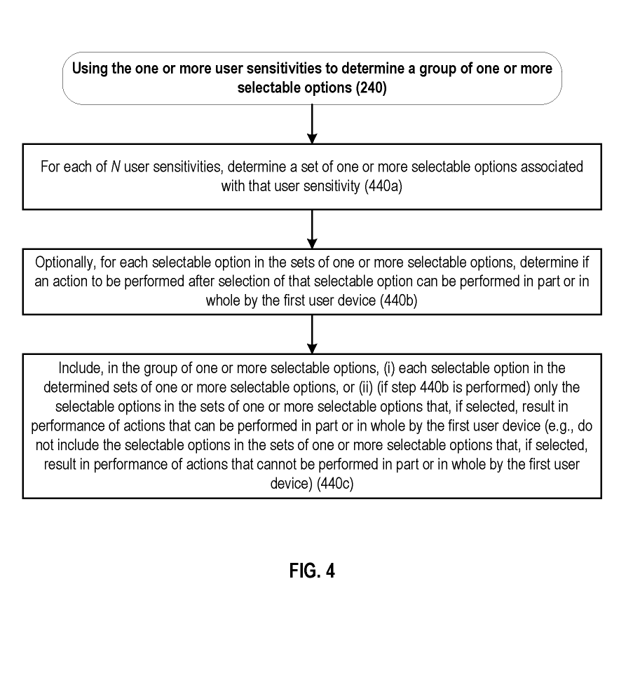

The one or more user sensitivities are used to determine a group of one or more selectable options (240). In one embodiment of step 240, the selectable options are looked up from a database of stored values representing particular selectable options that are associated with particular user sensitivities. By way of example, different selectable options available based on different user sensitivities are shown in the tables of FIG. 3A and 3B, which are described below. An embodiment for using the one or more user sensitivities to determine a group of one or more selectable options is shown in FIG. 4, described below.

The group of one or more selectable options is provided to the first user device for display to the first user (250), and the first user selects a first selectable option (260).

A first action associated with the first selectable option is performed in response to the user-initiated selection of the first selectable option by the first user (270). By way of example, different actions in response to selections of selectable options are listed in the tables of FIG. 3A and 3B, which are discussed later.

### Examples of Selectable Options that are Associated with User Sensitivities, and Examples of Performable Actions that are Associated with Selectable Options

FIG. 3A and FIG. 3B are tables including examples of selectable options associated with user sensitivities, and examples of performable actions or functions associated with selectable options. The user sensitivities, selectable options, and performed actions can be used in association with the method of FIG. 2, as performed by a combination of the user devices of FIG. 1B in the system of FIG. 1A. For each of the following examples, the first user device can be considered the originator of a collaborative virtual environment including at least one additional selected user device (e.g., a second, third, etc. user device).

A first selectable option includes establishing real-time communication between the first user device and the selected user device, which is associated with the following user sensitivities: real-time communication (e.g., audio, video, other) is allowed on the selected user device (e.g., microphone/speaker, screen/speaker are available); and/or real-time communication with users having a permission level of the first user is permitted. If this selectable option is selected, the following actions are performed: establish a real-time communication channel (e.g., a half-duplex, full duplex or other peer-to-peer channel) between the first user device and the selected user device; and capture and exchange real-time communication data between the first user device and the selected user device. In some cases, each user participating in the real-time communication may be granted permission to speak or otherwise communicate with the other user, and any user participating in the communication can terminate his or her participation in the communication. In some examples, received communications are recorded and stored for later access by any user via an associated user device (e.g., the first user, the selected user, or another user). In some embodiments, any number of users can join the communication after being selected by any of the users participating in the communication.

A second selectable option includes generating and transmitting a type of content to the selected user device (e.g., where different types of content can be selected), which is associated with the following user sensitivities: presentation of a type of content (e.g., text, image, video, audio, 3D object, or other content) is allowed on the selected user device (e.g., space for displaying text, image, or video content on a screen of the selected user device is available; e.g., a speaker for presenting sound is available; e.g. second user device is capable of projecting a 3D object, e.g. the second user is in a location that is conducive to projecting a 3D object); receiving the type of content from users having a permission level of the first user is permitted; and/or the permission level of the selected user permits receiving the content. If this (second) selectable option is selected, the following actions are performed: capture and store the content to be transmitted; establish a communication channel between the first user device and the selected user device (e.g., a peer-to-peer communication channel or proxied through the server or the platform 110); transmit the content to the selected user device; and present the transmitted content on the selected user device (e.g., text, images, 3D object or video are displayed on a screen of the receiving user device in a unobtrusive area of the screen or projected onto the physical space if the device is AR or projected into the virtual environment in an area that does not collide with other virtual content). In some examples, for display of text, images, 3D objects or video, part of a display area of a screen is identified as not being used, and that part is used to display the text, images, 3D object or video. In other examples, for display of text, images, 3D object or video, part of a display area of a screen is identified as not being positioned in a vision pathway from the user's eye to a physical object (on and AR user device) or virtual object (on a VR user device), and that part is used to display the text, images, 3D object or video so as not to block the user's view of the physical or virtual object. In another embodiment, for display of text, images, 3D object or video, the system creates an opaque, translucent, semi-transparent, or transparent version of the text, images, 3D object or video and displays that on the user's device. In other examples, received content is recorded and stored and a list of the received content is displayed for the second user to select content for display. In some examples this can include a miniature version of the entire environment that can be displayed, and the second user can selectively pick/choose which items to enlarge or view at full size. In this example the first user selects an option to allow the second user to selectively display the content and therefore both the content and the indication that the second user must take an action to selectively display the content is sent to the second user device. That is, the second user can decide when to display the content and where to place the content in the second user's environment. In some embodiments, any number of users can receive the content.

A third selectable option includes distributing video or image content from the selected user device to the first user device (and optionally other user devices), which is associated with the following user sensitivities: capturing video or image content by the selected user device is allowed (e.g., the selected user device has a camera; e.g., content displayed on a screen of the selected user device can be recorded); and/or sharing captured video or image content with users having a permission level of the first user is permitted. If this selectable option is selected, the following actions are performed: capture video or image content using the selected user device (e.g., by recording captured images using a camera of the selected user device, or recording frames of content displayed on a screen of the selected user device); establish a communication channel for transmitting live or previously recorded video or images between the selected user device and the first user device; transmit the captured content to the first user device; and present the transmitted content on the first user device.

A fourth selectable option includes muting the selected user device, which is associated with the following user sensitivities: the selected user device has a microphone; and/or (optionally) the selected user device is capturing audio content. If this selectable option is selected, the following actions are performed: prevent audio content captured by the selected user device from being presented by the first user device (e.g., to the first user). By way of example, the performed action may involve an intermediary device (e.g., the platform 110) receiving audio content from the selected user device, and that intermediary device not transmitting the audio content to the first user device. By way of another example, the performed action may involve the first user device receiving audio content from the selected user device, but not presenting the audio content to the first user. The originator can further control the other participant's (e.g., a second user device) privileges in the session.

A fifth selectable option includes disabling a talking privilege of the selected user, which is associated with the following user sensitivities: the selected user device has a microphone; the selected user device is capturing audio content; and/or the statuses of the first user and/or the selected user permits the first user to disable a talking privilege of the selected user. If this selectable option is selected, the following actions are performed: turn off the microphone of the selected user device (e.g., by transmitting instructions to the selected device that cause the microphone of the selected user device to be muted or otherwise turned off so as not to capture audio content); or prevent audio content captured by the selected user device from being presented by the first user device and other user devices (e.g., by transmitting instructions to the selected device that cause the selected device to not transmit audio content, by not passing audio content from the selected user device to the first and other user devices from an intermediary device (e.g., the platform 110), or by not presenting the audio content transmitted from the selected user device and received by the first and other user devices).

A sixth selectable option includes disabling a sharing privilege of the selected user, which is associated with the following user sensitivities: the selected user device is capable of generating sharable content, or capable of receiving input from the selected user that identifies sharable content; and/or the statuses of the first user and/or the selected user permits the first user to disable a sharing privilege of the selected user. If this selectable option is selected, the following actions are performed: turn off outbound communications of content from the selected user device (e.g., by transmitting instructions to the selected device that cause the selected device to not transmit content); or prevent content captured by the selected user device or identified by the selected user from being presented by the first user device and other user devices.

A seventh selectable option includes transmitting work instructions to the second user device, which is associated with the following user sensitivities: presentation of work instructions (e.g., text, image, video, audio, or other content) is allowed on the selected user device (e.g., space for displaying the work instructions on a screen of the selected user device is available; e.g., a speaker for presenting sound (if any) of the work instructions is available); and/or the permission level of the selected user permits receiving the work instructions at the selected user device. If this selectable option is selected, the following actions are performed: identify work instructions (e.g., by the first user selecting a file containing the work instructions from within a virtual environment); determine if the work instructions can be presented on the selected user device; if the work instructions can be presented on the selected user device, transmit the work instructions to the selected user device and present the work instructions using the selected user device; if the work instructions cannot be presented on the selected user device, determine if an alternative format of the work instructions can be presented on the selected user device; if the alternative format of the work instructions can be presented on the selected user device, generate the alternative format of the work instructions (as needed), transmit the alternative format of the work instructions to the selected user device, and present the alternative format of the work instructions using the selected user device; and if no alternative format of the work instructions can be presented on the selected user device, inform the first user and/or the selected user that the work instructions cannot be presented by the selected user device. By way of example, work instructions can be any information relating to a task to be performed by the selected user.

### Using the One or More User Sensitivities to Determine a Proup of One or More Selectable Options (Step 240)

FIG. 4 is a flowchart of a method for using the one or more user sensitivities to determine a group of one or more selectable options of the method of FIG. 2. For example, the method of FIG. 4 can be performed during step 240 of FIG. 2.

For each of N user sensitivities, a set of one or more selectable options associated with that user sensitivity are determined (440a). In step 440a, the sets of selectable options can be looked up from a database of selectable options that are stored in association with particular user sensitivities that can be used as search terms for identifying selectable options associated with those user sensitivities.

Optionally, for each selectable option in the sets of one or more selectable options that would require action by the first user device, a determination is made if an action to be performed after selection of that selectable option can be performed in part or in whole by the first user device (440b). Alternatively, for each selectable option in the sets of one or more selectable options that would require action by the second user device, a determination is made if an action to be performed after selection of that selectable option can be performed in part or in whole by the second user device.

Finally, different embodiments for including selectable options in the group of one or more selectable options may be implemented (440c). In one embodiment of step 440c, each selectable option in the determined sets of one or more selectable options is included in the group of one or more selectable options. In another embodiment (e.g., if step 440b is performed), only the selectable options in the sets of one or more selectable options that, if selected, result in performance of actions that can be performed in part or in whole by the first user device are included in the group of one or more selectable options (e.g., the selectable options in the sets of one or more selectable options that, if selected, result in performance of actions that cannot be performed in part or in whole by the first user device are not included). In yet another embodiment (e.g., if the alternative of step 440b is performed), only the selectable options in the sets of one or more selectable options that, if selected, result in performance of actions that can be performed in part or in whole by the second user device are included in the group of one or more selectable options (e.g., the selectable options in the sets of one or more selectable options that, if selected, result in performance of actions that cannot be performed in part or in whole by the second user device are not included).

### Technical Solutions to Technical Problems

Methods of this disclosure offer different technical solutions to important technical problems.

One technical problem is providing a collaboration environment such that users using AR and users using VR can collaborate together in the same collaboration session. The users using AR are limited by their physical space and the physical objects in the physical space. For example, an AR user participating from inside a 10 ft by 10 ft office space cannot fit a virtual replica of an oil rig into the physical space. In this example, the system or the users must make an informed decision on how to best represent the virtual objects to the AR users. In another example, a VR user is participating from a virtual environment that has multiple virtual objects already present in the space, when an AR user that cannot see the virtual environment or its content wants to collaborate on a virtual whiteboard, the AR user does not know where in the virtual space to place the whiteboard so it does not collide with other objects in the virtual space. In this example the VR user must be afforded control over the placement of the whiteboard in the virtual space. In addition, the movement of the whiteboard in the virtual space should not result in the movement of the whiteboard in the physical space for the AR user as a collision with a physical object or wall could occur.

A technical solution provided by the disclosure to provide methods for collaboration between AR users and VR users. The AR users experience the physical world and physical objects, while the VR users participate from a virtual environment with virtual objects. The size and placement of the virtual objects in the AR user's physical space can be problematic if the physical space is limited and/or there are many physical objects with which the virtual objects can collide.

Another technical problem is the AR user cannot see the virtual environment of the VR user. If the AR user wants to collaborate on a virtual object, the AR user has no idea where to place the virtual object. In addition, if the AR user wants to move a virtual object that the users are collaborating on (e.g. a virtual whiteboard), the VR user should not be affected by the move. That is, the AR user should be able to move the virtual object independently of the VR user (i.e. the VR user does not see the object move). The same is true for a VR user hosting a collaboration session with one or more AR users. The VR user should not control the placement of virtual objects in the physical space of the AR users because the VR user cannot see the physical space and therefore would not know where to place the virtual objects.

Another technical problem is providing user collaboration so more users can collaborate in new ways that enhance decision-making, reduce product development timelines, allow more users to participate, and provide other improvements. Solutions described herein provide improved user collaboration. Examples of such solutions include allowing particular users to communicate directly with each other or share content with each other while not necessarily sharing the content or communications with other users, or allowing one user (e.g., an administrator) to prevent another user from hijacking the collaborative session (e.g., by disabling privileges of that other user).

Another technical problem is delivering different content to different users, where the content delivered to each user is more relevant to that user. Solutions described herein provide improved delivery of relevant virtual content, which improves the relationship between users and sources of virtual content, and provides new revenue opportunities for sources of virtual content. Examples of such solutions include allowing particular users to communicate directly with each other or share relevant or of-interest content with each other.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies.

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics of each of the described embodiments may be combined in any suitable manner in one or more embodiments.

What is claimed is:

1. A method for operating a collaborative virtual environment among a plurality of user devices communicatively coupled to a platform providing the virtual environment, the method comprising:
establishing a collaboration session by one or more processors of the platform based on a request from a first user device of the plurality of user devices, the first user device being operated by a first user originating the collaboration session;
receiving, at the one or more processors, a selection input from the first user device, the selection input indicating selection of a second user device of the plurality of user devices to join the collaboration session;
determining, by the one or more processors, one or more user sensitivities associated with the second user device, the user sensitivities indicating operating characteristics of the second user device;
determining, by the one or more processors, one or more selectable options associated with each user sensitivity of one or more user sensitivities;
causing the one or more selectable options to be displayed at the first user device, the selectable options indicating one or more functions associated with the collaboration session between the first user device and the second user device;
receiving, in response to the displaying, a first user selection of a first selectable option; and
performing, by the one or more processors, a first function of the one or more functions, with regard to communications with the second user device, in response to the user selection of the first selectable option.

2. The method of claim 1 wherein the one or more functions comprises enabling the second user to selectively display virtual content of the collaborative session at the second user device.

3. The method of claim 1 further comprising:
determining if an action associated with each selectable option of the one or more selectable options can be performed in part or in whole by the first user device; and 440b
including in the one or more selectable options, only the selectable options in the one or more selectable options that, that if selected, result in performance of actions that can be performed in part or in whole by the first user device.

4. The method of claim 1 further comprising:
receiving a selection of a selected device at the first user device;
determining a location of the selected device; and
determining that the selected user device is the second user device based on the location of the selected user device.

5. The method of claim 1 further comprising performing the first function based on a permission level of the second user.

6. The method of claim 1 wherein the one or more selectable options comprise establishing or muting real-time communication between the first user device and the second user device based on a selection at the first user device.

7. The method of claim 1 wherein the one or more selectable options comprise transmitting content or disabling transmission of content between the first user device and the second user device based on a selection at the first user device.

8. The method of claim 7 wherein the content comprises a presentation of work instructions.

9. The method of claim 1, wherein the first user device comprises one of an augmented reality (AR) device and a virtual reality (VR) device and the second user device comprises the other of the AR device and the VR device.

10. A non-transitory computer-readable medium comprising instructions for operating a collaborative virtual environment among a plurality of user devices communicatively coupled to a platform providing the virtual environment, that when executed by one or more processors cause the one or more processors to:
establish a collaboration session by one or more processors of the platform based on a request from a first user device of the plurality of user devices, the first user device being operated by a first user originating the collaboration session;
receive a selection input from the first user device, the selection input indicating selection of a second user device of the plurality of user devices to join the collaboration session;
determine one or more user sensitivities associated with the second user device, the user sensitivities indicating operating characteristics of the second user device;
determine one or more selectable options associated with each user sensitivity of one or more user sensitivities;
cause the one or more selectable options to be displayed at the first user device, the selectable options indicating one or more functions associated with the collaboration session between the first user device and the second user device;
receive, in response to the displaying, a first user selection of a first selectable option; and
perform a first function of the one or more functions, with regard to communications with the second user device, in response to the user selection of the first selectable option.

11. The non-transitory computer-readable medium of claim 10 wherein the one or more functions comprises enabling the second user to selectively display the virtual content of the collaborative session at the second user device.

12. The non-transitory computer-readable medium of claim 10 further comprising instructions that cause the one or more processors to:
determine if an action associated with each selectable option of the one or more selectable options can be performed in part or in whole by the first user device; and
include in the one or more selectable options, only the selectable options in the one or more selectable options that, that if selected, result in performance of actions that can be performed in part or in whole by the first user device.

13. The non-transitory computer-readable medium of claim 10 further comprising instructions that cause the one or more processors to:
receive a selection of a selected device at the first user device;
determine a location of the selected device; and
determine that the selected user device is the second user device based on the location of the selected user device.

14. The non-transitory computer-readable medium of claim 10 further comprising instructions that cause the one or more processors to perform the first function based on a permission level of the second user.

15. The non-transitory computer-readable medium of claim 10 wherein the one or more selectable options comprise establishing or muting real-time communication between the first user device and the second user device based on a selection at the first user device.

16. The non-transitory computer-readable medium of claim 10 wherein the one or more selectable options comprise transmitting content or disabling transmission of content between the first user device and the second user device based on a selection at the first user device.

17. The non-transitory computer-readable medium of claim 16 wherein the content comprises a presentation of work instructions.

18. The non-transitory computer-readable medium of claim 10, wherein the first user device comprises one of an augmented reality (AR) device and a virtual reality (VR) device and the second user device comprises the other of the AR device and the VR device.
